(19) United States
(12) Patent Application Publication
(10) Pub. No.: US 2015/0286255 A1
(43) Pub. Date: Oct. 8, 2015

(54) VARIABLE FRICTION CLUTCH FOR A PORTABLE COMPUTER

(71) Applicant: Apple Inc., Cupertino, CA (US)

(72) Inventors: Bradley J. Hamel, Redwood City, CA (US); Christiaan A. Ligtenberg, San Carlos, CA (US); Brett W. Degner, Menlo Park, CA (US)

(73) Assignee: Apple Inc., Cupertino, CA (US)

(21) Appl. No.: 14/247,027

(22) Filed: Apr. 7, 2014

(51) Int. Cl. G06F 1/16

(52) U.S. Cl. CPC G06F 1/1681; G06F 1/1613

(57) ABSTRACT

Variable friction clutch structures are described. In particular embodiments, the variable friction clutch structures are used to provide smooth and consistent movement of hinge assemblies of portable computers. The variable friction clutch can be configured to transition between a high frictional resistance mode and a low frictional resistance mode. In some embodiments, the variable friction clutches include cam systems. In some embodiments, the variable friction clutches include threaded shaft systems. In some embodiments, the variable friction clutches include mechanical linkage systems. In some embodiments, two or more variable friction clutches are included within a single hinge assembly for a portable computer. A space-saving wire clutch that can be used alone or in combination with the variable friction clutches is disclosed.

### FIELD

This disclosure relates generally to portable computers and, more particularly, to clutch structures and systems as part of portable computers.

### BACKGROUND

Portable computers typically have a clamshell form factor that includes an upper housing portion and a lower housing portion connected together by a hinge assembly that includes a clutch. The lower housing portion typically contains components such as circuit boards, disk drives, a keyboard, and a battery. The upper housing portion typically contains a display. When the portable computer is in an open configuration, the upper housing portion is upright such that the display is visible to a user of the portable computer. When the computer is in a closed configuration, the upper housing typically lies flat against the lower housing portion. In the closed configuration, the display and keyboard are protected during transport of the portable computer.

The clutch for a portable computer can be difficult to design. For example, it is generally desirable that the clutch does not have overly high torque such that a user will have to exert a large amount of prying force to open the portable computer. However, the clutch should not have such low torque that the upper housing is not able to retain an upright position while the user is using the portable computer. In addition, the clutch should be designed such that the user can easily and smoothly transition the portable computer between the open and closed configurations.

### SUMMARY

This paper describes various embodiments that relate to variable friction clutch structures for use in computing devices.

According to one embodiment, a variable friction clutch rotatably coupling a first piece and a second piece is described. The variable friction clutch includes a fork having two extended members that cooperate to define a notch. The variable friction clutch also includes a cam shaft having a variable engagement surface that frictionally engages the two extended members in a manner that provides a resistance that varies in accordance with an angular displacement between the first and second pieces.

According to another embodiment, portable computer having a base and a lid is described. The portable computer includes a hinge assembly rotatably coupling the base and the lid such that the lid rotates with respect to the base along a rotational axis. The hinge assembly includes a variable friction clutch. The variable friction clutch includes a fork having a notch defined by two extended members. The variable friction clutch also includes a cam shaft positioned within the notch and frictionally coupled to the two extended members. The cam shaft has a rotational axis corresponding to the rotational axis of the hinge assembly. The cam shaft has a non-circular cross-section that provides a variable frictional force when the cam shaft rotates within the notch. The variable frictional force is associated with a variable opening force curve of the hinge assembly.

According to an additional embodiment, a method of customizing a hinge assembly for a portable computer is described. The method includes forming a variable friction clutch configured to provide a variable frictional resistance. The variable friction clutch is configured to transition between a high frictional resistance mode and a low frictional resistance mode. The method also includes associating the low frictional resistance mode of the variable friction clutch with the maximum force applied by gravity. The method also includes associating the high frictional resistance mode of the variable friction clutch with the minimum force applied by gravity.

These and other embodiments will be described in detail below.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of a portable computer with hinge assembly having variable clutch structures in accordance with described embodiments.

FIG. 2 shows a graph showing opening and closing force curves for a hinge assembly having a constant friction clutch.

FIG. 3 shows a graph showing opening and closing force curves for a hinge assembly having a variable friction clutch.

FIGS. 4A and 4B show cross-section views of a variable friction clutch having a cam system accordance with some embodiments.

FIGS. 5A and 5B show side views of a variable friction clutch having a threaded shaft in accordance with some embodiments.

FIG. 5C shows a side view of an alternative embodiment of a variable friction clutch that includes a threaded shaft in accordance with some embodiments.

FIGS. 6A and 6B show side views of a portable computer that includes a variable friction clutch using a four-bar linkage mechanism in accordance with some embodiments.

FIGS. 7A and 7B show perspective views of portions of wire clutches in accordance with some embodiments.

FIG. 8 shows a high level flowchart indicating a process for customizing a hinge assembly for a portable computing device in accordance with some embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure relates to clutch structures used in consumer products. The consumer products can include electronic devices such as computers, mobile devices, and accessories, such as those manufactured by Apple Inc., based in Cupertino, Calif. In particular embodiments, the clutch structures are used as part of a hinge system for hinging a lid to a base of a portable computer. The clutch structures can provide variable frictional resistance to rotational movement of the lid with respect to the base. The variable friction clutches can provide a smoother and more consistent user experience when opening and/or closing the portable computer compared to conventional clutch structures. In addition, the variable friction clutch can reduce the amount of stored energy within the clutch such that the lid is less likely to inadvertently open when the portable computer is in a closed position. In addition, there can be less likelihood of a gap forming between the lid and the base when the portable computer is in a closed position. It can provide these advantages without compromising the hinge holding force while the display is open.

According to some embodiments, the variable friction clutch structures are designed to transition between a high frictional resistance mode and a low frictional resistance mode. The high frictional resistance mode and a low frictional resistance mode can be associated with or aligned with the rotating movement of the lid with respect to the base of a portable computer. The variable friction clutches can be designed to provide a customized opening force curve and closing force curve of the portable computer. In some embodiments, more than one variable friction clutch is used within a hinge assembly of a portable computer. In some embodiments, the one or more variable friction clutches are combined with one or more non-variable friction clutches within a hinge assembly.

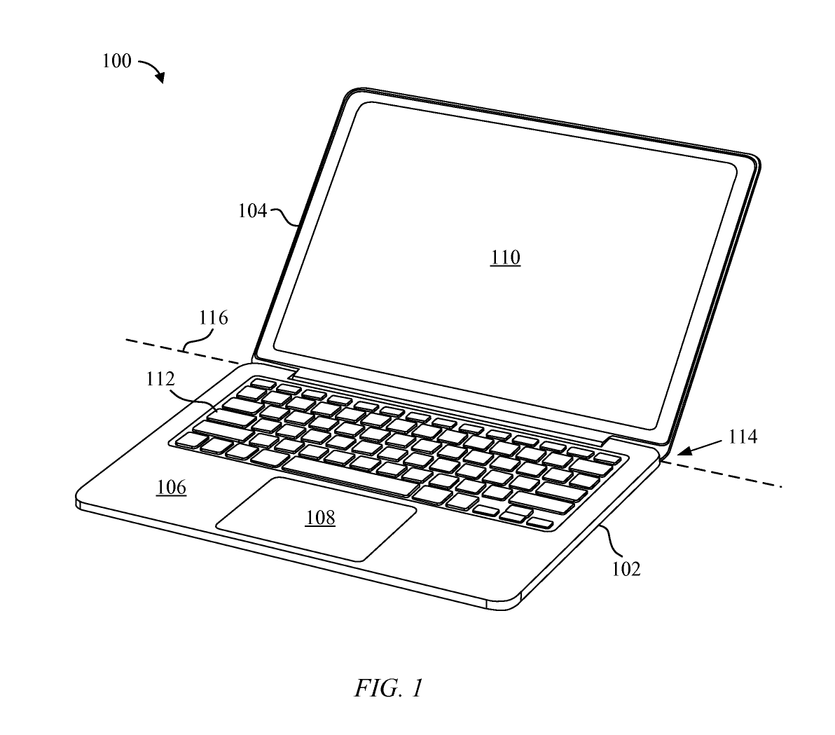

These and other embodiments are discussed below with reference to FIGS. 1-8. However, those skilled in the art will readily appreciate that the detailed description given herein with respect to these Figures is for explanatory purposes only and should not be construed as limiting.

FIG. 1 shows a perspective view of portable computer 100 having a hinge assembly with variable friction clutch structures in accordance with some embodiments. Portable computer 100 includes base 102 and lid 104. Base 102 includes top case 106 with track pad 108 and keyboard 112. Track pad 108 can include a tactile sensor that is sensitive to a user's finger. The sensor translates the motion and position of the user's finger to a relative position of a pointer displayed on screen 110. Keyboard 112 allows a user to enter input to portable computer 100 by typing. Each of base 102 and lid 104 can be made of any suitable material, such as plastic, metal, ceramic, glass or a combination thereof. If metal materials are used, the metal surfaces can have a protective metal oxide coating. For example, aluminum and/or aluminum alloy surfaces can have a protective aluminum oxide coating. In some cases, the metal oxide coatings are dyed to have a particular color.

Base 102 and lid 104 can each house functional components. For example, base 102 can house a main logic board, one or more batteries and one or more memory devices. Lid 104 can house a display assembly associated with screen 110. The display assembly can be any suitable type of display assembly including a liquid crystal display (LCD) assembly and/or an organic light-emitting diode (OLED) assembly. Base 102 is rotatably coupled with lid 104 via hinge assembly 114, which can be configured to rotate lid 104 relative to base 102 about rotational axis 116. Hinge assembly 114 can be further configured to allow components of base 102 to communicate with components of lid 104 via wires, cables or other suitable communication mechanism. In a closed position, lid 104 can be at a zero, or approximately zero, angle relative to base 102. In some embodiments, portable computer 100 has a mechanism for securing lid 104 to base 102 when in a closed position. For example, each of lid 104 and base 102 can have magnetically attractable elements (not shown) that use magnetic force to keep lid 104 secured to base 102 in the closed configuration. Additionally or alternatively, a mechanical latching system (not shown) can be used to keep lid 104 secured to base 102 in the closed configuration. Hinge assembly 112 can include one or more variable friction clutches that provide a variable frictional resistance against rotational movement of lid 104 with respect to base 102. The variable frictional resistance can provide sufficient force to allow lid 104 to remain in any of a number of non-zero angle (upright position) relative to base 102. The variable frictional resistance can also allow a user to smoothly and easily open and close lid 104.

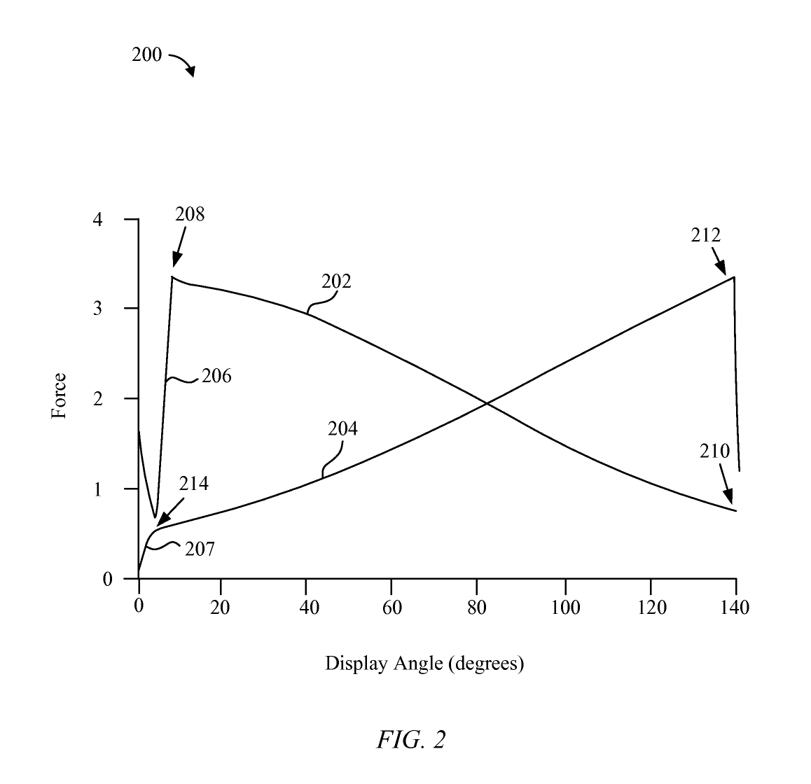

Some hinge assemblies include a constant friction clutch. FIG. 2 shows graph 200 showing opening and closing force curves for a hinge assembly that includes a constant friction clutch. The display angle (x axis) represents the relative angle of a lid of a portable computer relative to a base of the portable computer when rotated about the rotational axis of the hinge assembly. The force (y axis) represents the resistance force when rotating the lid relative to the base about the rotational axis. The force (y axis) represents the force that a user will have to exert when opening and closing the lid relative to the base.

Curve 202 represents the opening force profile as a function of display angle. Line segment 206 of curve 202 corresponds to a magnetic resistance of magnetically attractable elements of the lid and base used to keep the lid and base in a closed position. Peak opening force 208 corresponds to the highest amount of opening force required by the user during opening of the portable computer. Minimum opening force 210 corresponds to the least amount of opening force required by the user during opening of the portable computer. Curve 204 represents the closing force profile as a function of display angle. Line segment 207 of closing force curve 204 corresponds to a magnetic force when the magnetically attractable elements of the lid and base come in proximity to each other and assist closing of the lid with respect to the base. Peak closing force 212 corresponds to the highest amount of closing force required by the user during closing of the portable computer. Minimum closing force 214 corresponds to the least amount of closing force required by the user during closing of the portable computer.

As shown, the constant friction clutch shows a peak opening force 208 and a minimum opening force 210. From a user's perspective, this means force felt by the user in opening of the lid is inconstant and varies relatively widely. In particular, the large force difference can give the user an inconsistent feel when opening the lid. In addition, the force resistance for keeping the lid upright will vary widely depending upon the display angle of the lid relative to the base. To address this and other issues, described herein is a variable friction clutch that can be used instead of or in combination with a constant friction clutch and that provides less force variation during opening and closing of the portable computer.

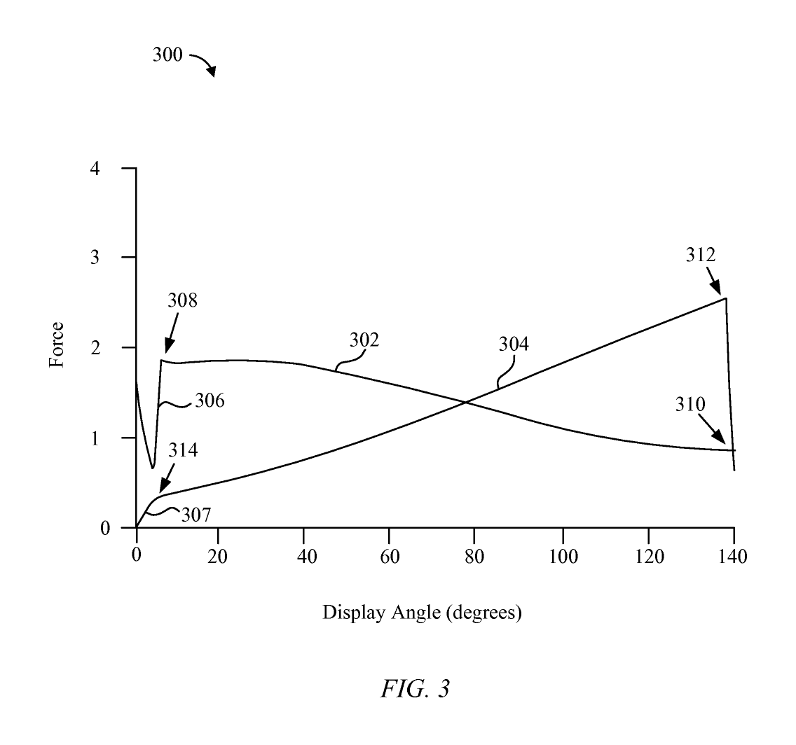

FIG. 3 shows graph 300 showing opening and closing force curves for a hinge assembly having a variable friction clutch. Curve 302 represents the opening force profile as a function of display angle. Line segment 306 of opening force curve 302 corresponds to a magnetic resistance of magnetically attractable elements of the lid and base used to keep the lid and base in a closed position. Peak opening force 308 corresponds to the highest amount of opening force required by the user during opening of the portable computer. Minimum opening force 310 corresponds to the least amount of opening force required by the user during opening of the portable computer. Curve 304 represents the closing force profile as a function of display angle. Line segment 307 of closing force curve 304 corresponds to a magnetic force when the magnetically attractable elements of the lid and base come in proximity to each other and assist closing of the lid with respect to the base. Peak closing force 312 corresponds to the highest amount of closing force required by the user during closing of the portable computer. Minimum closing force 314 corresponds to the least amount of closing force required by the user during closing of the portable computer.

As shown, the hinge assembly with the variable friction clutch is characterized as having a peak opening force 308 and a minimum opening force 310. Thus, the opening force experienced by the user is less variable than the constant friction clutch described above with respect to FIG. 2. In addition, since the peak opening force 308 is much less than the peak opening force 208 of the constant friction clutch, the amount of stored energy of the variable friction clutch is much less than the amount of stored energy of the constant friction clutch. This means that the variable friction clutch makes the lid less likely to pop open when the portable computer is in a closed position. This can be important, for example, when the portable computer not on a flat surface where that gravity helps to keep the lid down against the base. In addition, there will be less likelihood of a large gap forming between the lid and the base when in a closed position. Furthermore, the lid will be less likely to bow due to the magnetic force keeping the lid secured to the base when in a close position. This can equate to a lesser likelihood of bending and damage to components of the lid, such as display assemblies.

The variable friction clutches described herein can provide a variable frictional resistance against a rotation of a lid from a closed position to an open position relative to a base of a portable computer. The variable friction clutches are configured to transition between a high frictional resistance mode and a low frictional resistance mode. The high and low frictional resistance modes of the variable friction clutch can be aligned with or associated with the appropriate display angles of the lid with respect to the base. For example, the low frictional resistance mode of the variable friction clutch can be associated with and reduce a peak opening force (e.g., 308) and/or a peak closing force (e.g., 312) of the hinge assembly and portable computer. Similarly, the high frictional resistance mode can be associated with and increase the minimum opening force (e.g., 310) and/or the minimum closing force (e.g., 314) of the hinge assembly and the portable computer. This provides for smoother opening and/or closing of the portable computer.

It should be noted that graph 300 represents force profiles in accordance with some embodiments of a variable friction clutch. Graph 300 does not necessarily represent desired opening/closing force profiles for every embodiment described herein. For example, the absolute forces may differ on a case-by-case basis. In addition, the peak and minimum forces of curves 302 and 304, as well as the shape of curves 302 and 304, may differ. The variable friction clutches described herein can be used to form hinge assemblies having any suitable opening/closing force profiles. In fact, the variable friction clutches can be used to provide hinge assemblies with customized opening/closing force profiles.

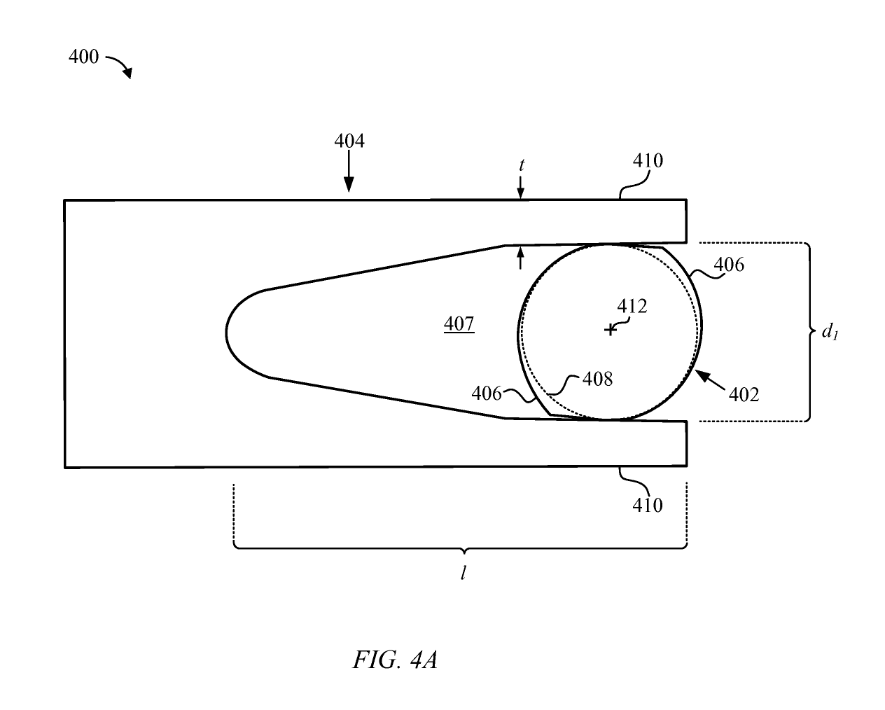

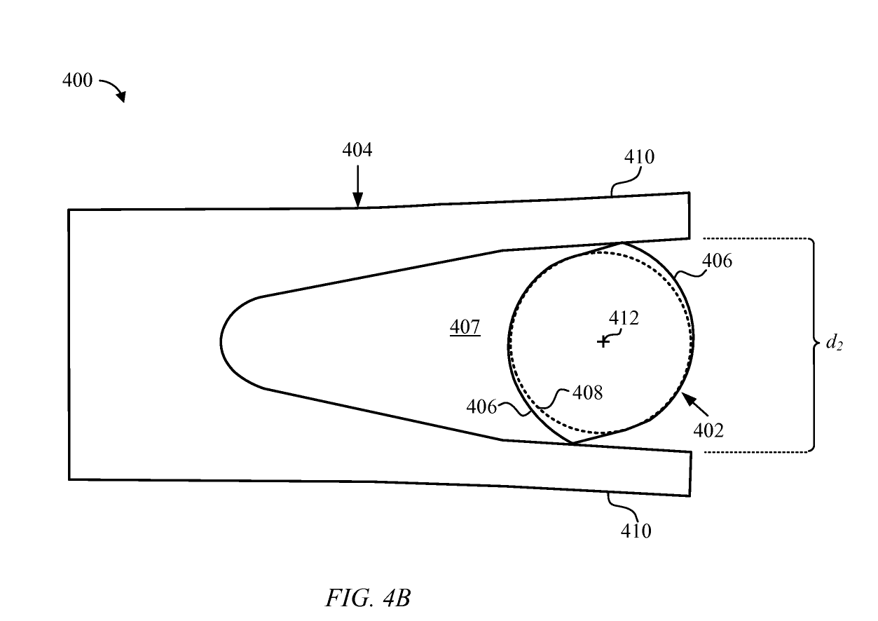

One way to achieve a variable friction clutch is by using a cam system. FIGS. 4A and 4B show cross-sections of variable friction clutch 400 having a cam system accordance with some embodiments. One or more clutches 400 can rotatably couple a first piece and a second piece, such as lid 104 and base 102 of portable computer 100 shown in FIG. 1. In one embodiment, two clutches 400 are used within portable computer 100. Clutch 400 includes cam 402 and fork 404. Cam 402 is positioned within notch 407 formed within fork 404 and defined by extended members or tines 410. Cam 402 is frictionally coupled to tines 410. Cam 402 rotates within fork 404 along rotational axis 412 during closing and opening of the lid of the portable computer. In some embodiments, rotational axis 412 corresponds to rotational axis 116 of hinge assembly 114 of portable computer 100.

As shown, cam 402 has an asymmetric cross-section in that lobes 406 give cam 402 a non-circular cross-section. That is, lobes 406 correspond to portions of cam 402 that deviate from reference circle 408. Cam 402 can have any suitable non-circular cross-sectional shape, including oval, triangular, rectangular, irregular, anisotropic, or other suitable geometric shape. Thus, cam 402 has a variable engagement surface that can frictionally engage with tines 410 during rotation. Cam 402 can be in the form of a singular shaft or can be a piece that is part of a larger shaft within hinge assembly 114. In some embodiments, cam 402 is mechanically coupled with base 102 of a portable computer 100 and fork 404 is mechanically coupled with lid 104 of portable computer 100. This way, the relative movement of cam 402 is coupled with the relative movement of fork 404 and the relative movement of fork 404 is coupled with relative movement of lid 104. In alternative embodiments, cam 402 is mechanically coupled with lid 104 of portable computer 100 and fork 404 is mechanically coupled with base 102 of portable computer 100.

When a user opens and closes lid 104 of portable computer 100, cam 402 rotates with respect to fork 404. In some embodiments, a lubricant is provided within spaces of variable friction clutch 400 to provide fluid movement. FIG. 4A shows variable friction clutch 400 in a first rotational position where distance d₁ between tines 410 is relatively small. In the first rotational position, clutch 400 is in a low frictional resistance mode since the frictional force between cam 402 and tines 410 is relatively low. FIG. 4B shows variable friction clutch 400 in a second rotational position after cam 402 is rotated with respect to fork 404. In the second rotational position, lobes 406 engage with tines 410 and cause tines 410 to separate to an increased distance d₂. This increased distance d₂ results in a higher clamping force on cam 402. The higher clamping force results in a higher frictional force between cam 402 and tines 410. The increased frictional force provides additional resistance to turning of cam 402. Thus, in the second rotational position, clutch 400 is in a high frictional resistance mode. In this way, clutch 400 can provide a varying frictional resistance.

Clutch 400 can be configured within a hinge assembly to provide high frictional resistance and low frictional resistance during predetermined display angles of the portable computer. For example, clutch 400 can be configured to be in the low frictional resistance mode (FIG. 4A) at a display angle corresponding to peak opening force 308 of opening force curve 302 of FIG. 3. In this way, clutch 400 can reduce a peak opening force compared to a hinge system using a non-variable friction clutch. In addition, the amount of stored energy in the hinge assembly is reduced when the portable computer is in a closed position, reducing the likelihood of the lid popping open and/or bowing. Similarly, clutch 400 can be configured to be in a high frictional resistance mode (FIG. 4B) at a display angle corresponding to minimum opening force 310 of opening force curve 302 of FIG. 3. The high and low frictional resistance modes of clutch 400 can additionally or alternatively be configured within the hinge assembly to correspond to peak closing force 312 and minimum closing force 314 of closing force curve 304.

The geometry of cam 402 and fork 404 can vary, as well as the contact angle between cam 402 and fork 404, to customize the amount of frictional force that is provided by clutch 400 and applied to lid 104. For example, the diameter of cam 402 can be increased or decreased and/or the shape of cam 402 can be modified to impact the amount of fiction and displacement of tines 410 and to increase or decrease the amount of frictional force provided by clutch 400. Alternatively or additionally, length l and thickness t of tines 410 can be increased or decreased to increase or decrease the amount of friction force provided by clutch 400. Alternatively or additionally, the contact angle between cam 402 and fork 404 can be chosen to increase or decrease the amount of frictional force provided by clutch 400. In some cases, the number of variable friction clutches 400 used within a hinge assembly 114 can be increased to serialize the load that each of the clutch 400 takes on. In addition, the material of cam 402 and/or fork 404 can be chosen to provide a desired amount of frictional force and/or wear resistance. In these ways, variable friction clutch 400 can be customized to provide a hinge assembly for a portable computer having a customized opening force curve and/or closing force curve.

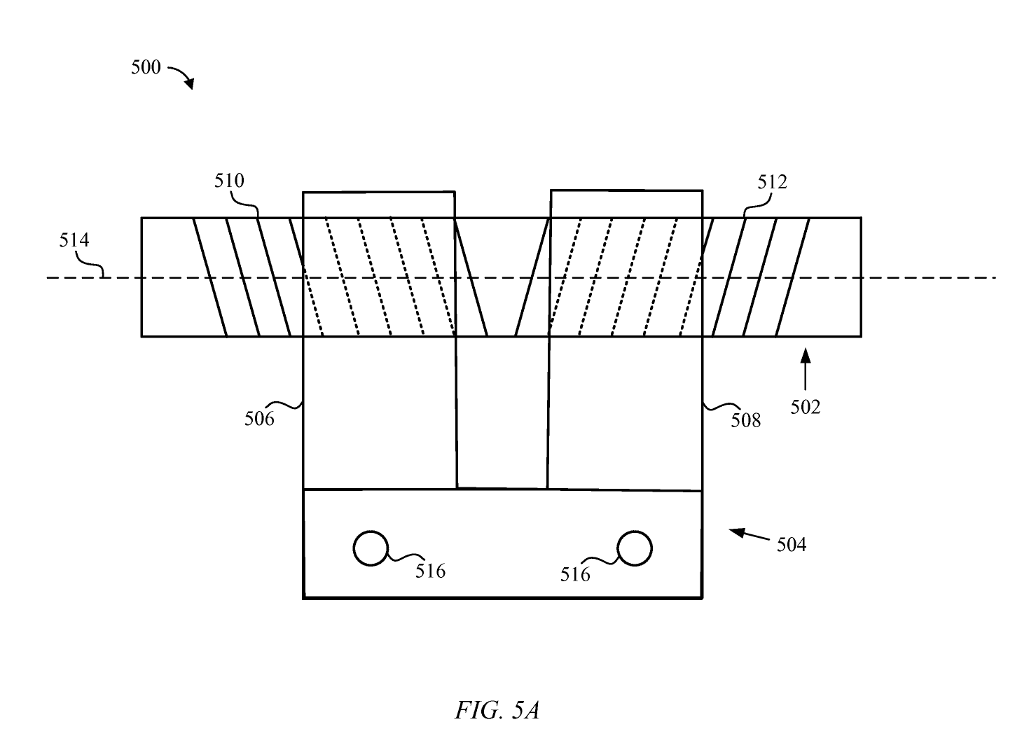

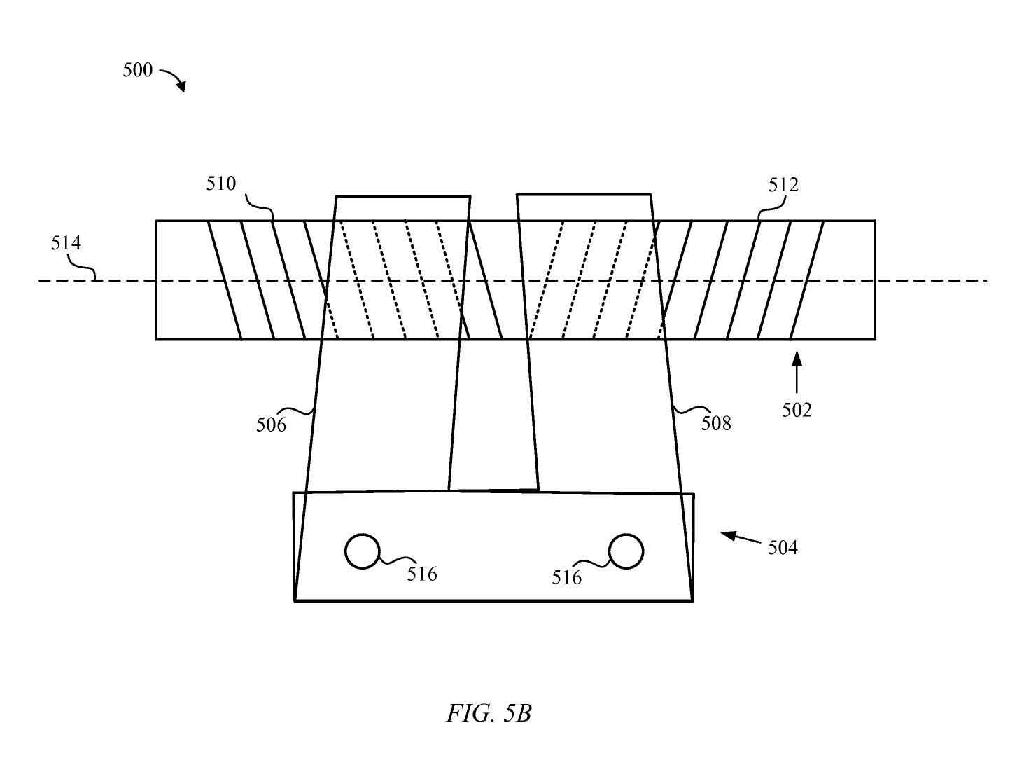

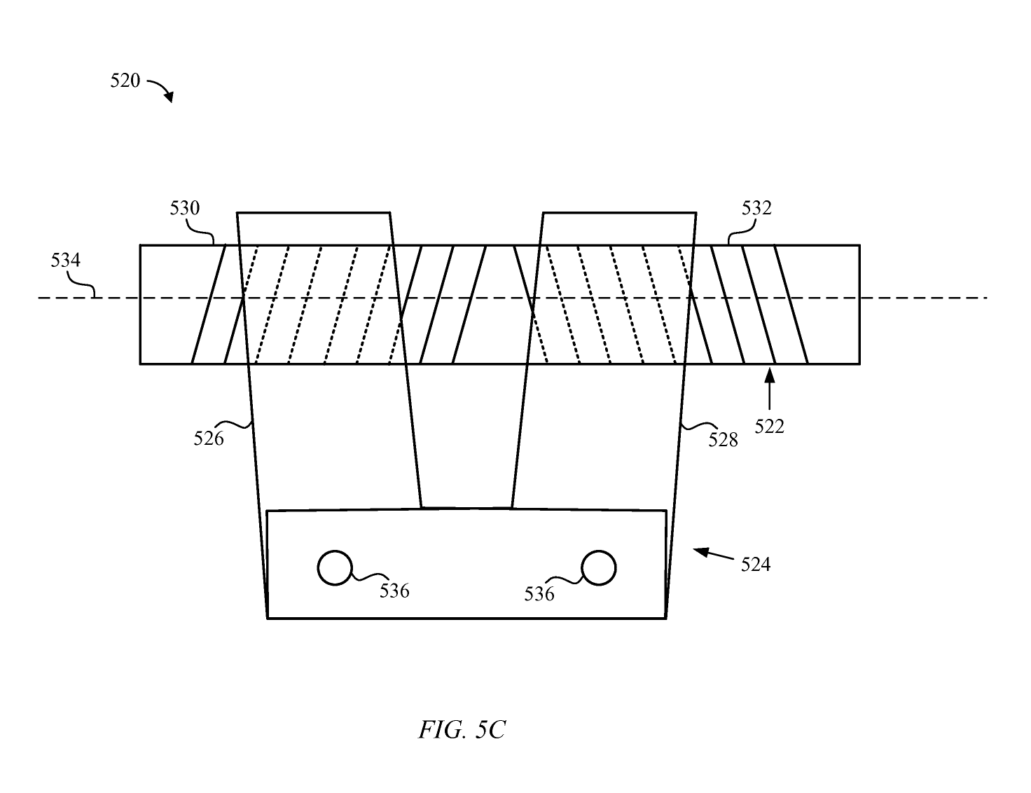

Another way to achieve a variable friction clutch is by using a threaded shaft system. FIGS. 5A and 5B show side views of variable friction clutch 500 having a threaded shaft in accordance with some embodiments. One or more clutches 500 can be part of hinge assembly 114 of portable computer 100 shown in FIG. 1. In one embodiment, two clutches 500 are used within portable computer 100. Variable fiction clutch 500 includes shaft 502 and collar 504. Shaft 502 rotates along rotational axis 514 when lid 104 is opened and closed. In some embodiments, shaft 502 has rotational axis 514 that corresponds with rotational axis 116 of portable computer 100. Shaft 502 includes first set of threads 510 oriented in a first direction and second set of threads 512 oriented in a second direction opposite the first direction. Collar 504 includes first extended piece 506 and second extended piece 508. In some embodiments, first extended piece 506 and second extended piece 508 each has an l-shape, as shown in FIGS. 5A and 5B. However, first extended piece 506 and second extended piece 508 can have any suitable shape. In other embodiments, collar 504 does not include separate pieces and instead embodied within as singular u-shaped or v-shaped piece. First extended piece 506 has an opening for providing shaft 510 therethrough and has a set of internal threads corresponding to first set of threads 510. Second extended piece 508 has an opening for providing shaft 510 therethrough and has a set of internal threads corresponding to second set of threads 512. Holes 516 can be used to accommodate fasteners to fasten first extended piece 506 to second extended piece 508. In some embodiments, shaft 502 is mechanically coupled with base 102 of portable computer 100 and collar 504 is mechanically coupled with lid 104 of portable computer 100. In alternative embodiments, shaft 502 is mechanically coupled with lid 104 of portable computer 100 and collar 504 is mechanically coupled with base 102 of portable computer 100.

When a user opens and closes lid 104 of portable computer 100, shaft 502 rotates within the threaded openings of collar 504. In some embodiments, a lubricant is provided between the threads of shaft 502 and collar 504 to provide fluid movement. FIG. 5A shows variable friction clutch 500 in a first position where each of first extended piece 506 and second extended piece 508 is in a neutral position. In the first position, clutch 500 is in a low frictional resistance mode since the frictional force between shaft 502 and collar 504 via threads 510 and 512 is relatively small. FIG. 5B shows variable friction clutch 500 in a second position where each of first extended piece 506 and second extended piece 508 are drawn closer to each other due to the opposite threaded portions 510 and 512. As first extended piece 506 and second extended piece 508 move toward each other, the frictional force between shaft 502 and collar 504 via threads 510 and 512 increases. The increased frictional force provides additional resistance to turning of shaft 502. Thus, in the second position clutch 500 is in a high frictional resistance mode.

Clutch 500 can be configured within a hinge assembly to provide high frictional resistance and low frictional resistance during predetermined display angles of a portable computer. For example, clutch 500 can be configured to be in the low frictional resistance mode (FIG. 5A) at a display angle corresponding to peak opening force 308 of opening force curve 302 of FIG. 3. In this way, clutch 500 can reduce a peak opening force compared to a hinge system using a non-variable friction clutch. In addition, the amount of stored energy in the hinge assembly is reduced when the portable computer is in a closed position, reducing the likelihood of the lid popping open and/or bowing. Similarly, clutch 500 can be configured to be in a high frictional resistance mode (FIG. 5B) at a display angle corresponding to minimum opening force 310 of opening force curve 302. The high and low frictional resistance modes of clutch 500 can additionally or alternatively be configured within the hinge assembly to correspond to peak closing force 312 and minimum closing force 314 of closing force curve 304.

The geometry of shaft 502 and collar 504 can vary to customize the amount of frictional force that is provided by clutch 500 and imposed on the opening and/or closing forces of portable computer 100. For example, the pitch of first set of threads 510 and second set of threads 512 can be customized to create less or more frictional force upon opening and/or closing of portable computer 100. In some cases, the number of variable friction clutches 500 used within hinge assembly 114 can be increased to serialize the load that each of the clutch 500 takes on. In addition, the material of shaft 520 and collar 504 can be chosen to provide a desired amount of friction and/or wear resistance. In these ways, variable friction clutch 400 can be customized to provide a hinge assembly for a portable computer having a customized opening force curve and/or closing force curve.

FIG. 5C shows an alternative embodiment of a variable friction clutch that includes a threaded shaft. Variable clutch 520 includes shaft 522 and collar 524. Shaft 520 has rotational axis 534 that corresponds with rotational axis 116 of portable computer 100 and rotates along rotational axis 534 when lid 104 is opened and closed. Shaft 520 includes first set of threads 530 oriented in a first direction and second set of threads 532 oriented in a second direction opposite the first direction. Variable friction clutch 520 is similar to variable friction clutch 500 described above, except that first set 530 and second set 532 of threads are oriented in different directions. Collar 524 includes first extended piece 526 and second extended piece 528. First extended piece 526 and second extended piece 528 can each have any suitable shape, including an l-shape as shown in FIG. 5C. In other embodiments, collar 524 does not include separate pieces and instead embodied within a singular u-shaped or v-shaped piece. When a user opens and closes lid 104 of portable computer 100, shaft 522 rotates within the threaded openings of collar 524, similar to variable fiction clutch 500 described above. However, in the clutch 520 is configured such that each of first extended piece 526 and second extended piece 528 move farther apart with respect to each other due to the opposite threaded portions 530 and 532. This increases the frictional force between shaft 522 and collar 524 provides additional resistance to turning of shaft 522 at certain display angles when closing and/or opening lid 104. As with variable clutch 500, the geometry of shaft 522 and collar 524 can be chosen to provide a portable computer having a customized opening and/or closing force profile. In some embodiments, one or more variable friction clutches 500 is combined with one or more variable friction clutched 520 within one hinge system.

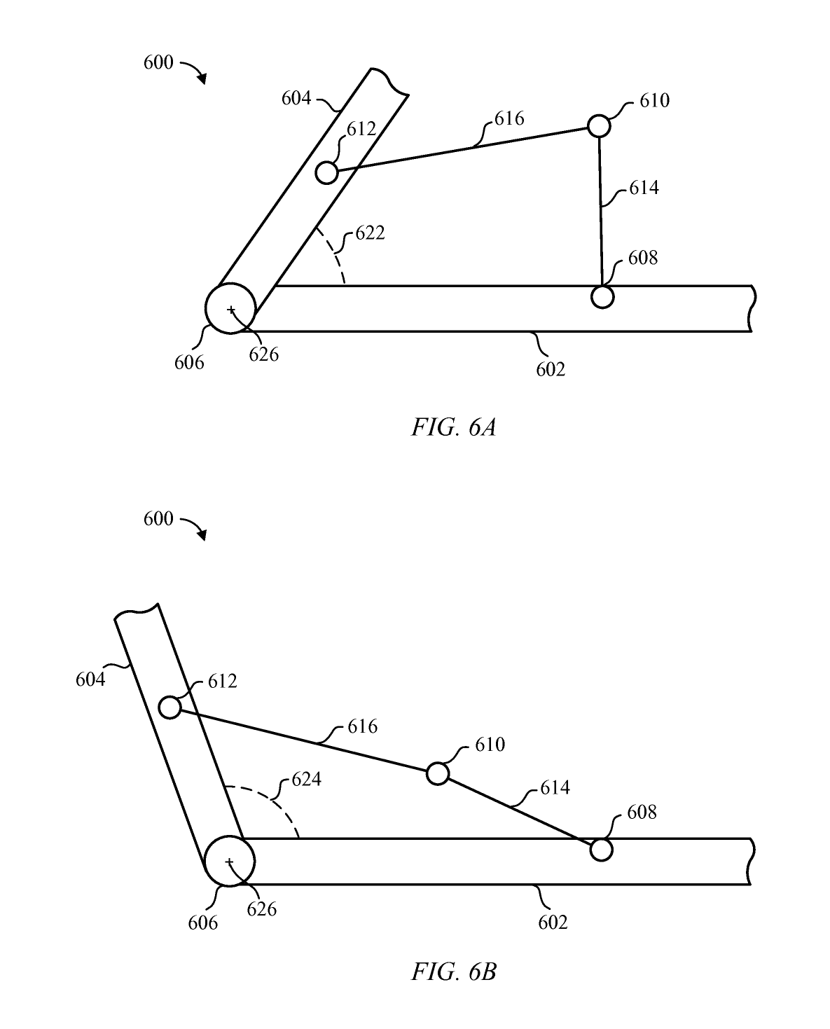

Another way to achieve a variable friction clutch is by using a mechanical linkage system, such as a four-bar linkage. FIGS. 6A and 6B show schematic side views of portable computer 600, which uses a four-bar linkage mechanism in accordance with described embodiments. Portable computer 600 includes base 602, lid 604 and hinge assembly 606. FIG. 6A shows portable computer 600 in a first state, wherein lid 604 is at a first display angle 622 with respect to base 602. FIG. 6B shows portable computer 600 in a second state, wherein lid 604 is at a second display angle 624, larger than first display angle 622, with respect to base 602. Hinge assembly 606 can include any suitable hinge mechanism. In some embodiments, hinge assembly 606 includes one or more clutch structures, such as one or more of the variable friction clutch structures described above. Portable computer 600 includes a four-bar linkage, represented by elements 614, 616, base 602 and lid 604, which are coupled at hinge 606 and joints 608, 610 and 612. Joint 608 is fixed to base 602 and joint 612 is fixed to lid 604. Note that the four-bar linkage shown in FIGS. 6A and 6B represent an exemplary configuration of a four-bar linkage system and should not be construed as the only possible configuration. For example, in some embodiments, all elements and joints of the four-bar linkage, including elements 614/616 and joint 610, are housed entirely within a housing of portable computer 600.

During opening and closing of portable computer 600, lid 604 rotates with respect to base 602 along rotational axis 626 of hinge assembly 606. Also during the opening and closing, elements 614, 616, base 602 and lid 604 each maintain fixed lengths, while hinge 606 and joints 608, 610 and 612 each provide a degree of freedom. In some embodiments, one or more stops can be used to prevent over-rotating of joint 610 past a predetermined angle. Hinge 606 and joints 608, 610 and 612 can each act as friction elements that can provide frictional forces against the opening and/or closing motions. The four-bar linkage can be designed to increase or decrease the speed of opening and/or closing motion, or at portions of each of the opening and/or closing motions. By virtue of the variable turn rates provided by the four-bar mechanism, one can vary an amount of friction at different points of movement of lid 604 with respect to base 602. That is, the four-bar linkage of portable computer 600 can be configured to provide slower movement where less frictional resistance is desired and faster movement where more frictional resistance is desired. In this way, a four-bar linkage system, such as shown in FIGS. 6A and 6B, can be customized to create a variable clutch system having the opening force curve 302 and/or closing force curve 304 of FIG. 3.

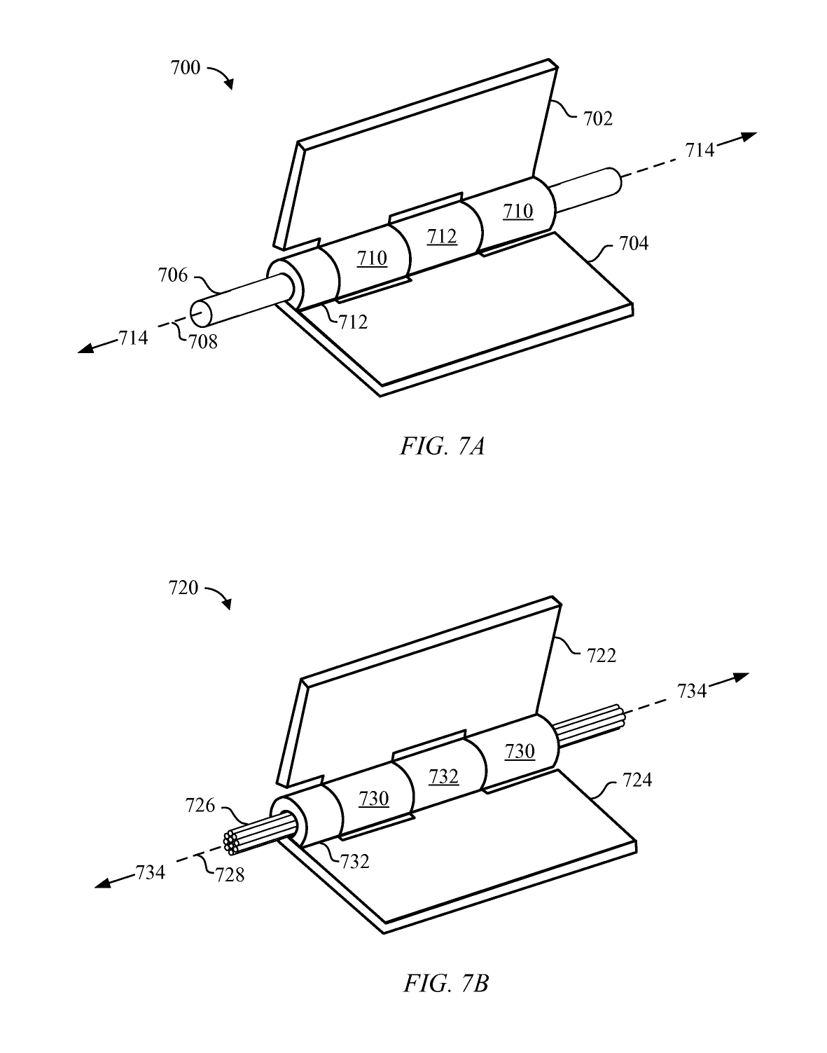

In some embodiments, the clutch is designed to take up minimal space within the portable computer. For example, a wire or a number of wires can be used instead of a relatively large central shaft. FIGS. 7A and 7B show perspective views of portions of wire clutches 700 and 720, respectively, in accordance with described embodiments. Wire clutches 700 and 720 can each be part of a hinge assembly for a portable computer, such as hinge assembly 114 of portable computer 100 described above. In some embodiments, wire clutches 700 and 720 each span substantially the entire length of hinge assembly 114. In other embodiments, wire clutches 700 and 720 each span a portion of hinge assembly 114. In some embodiments, more than one wire clutches 700 and/or 720 are used within hinge assembly 114. Since wire clutches 700 and 720 include wires instead of relatively larger shafts, they can have a smaller overall cross section and take up less room within hinge assembly 114. This can leave more space for other components, such as cables used to electrically pass information between components housed within base 102 and lid 104. Wire clutches 700 and 720 can each be used in combination with one or more variable friction clutch systems, such as those described above with reference to FIGS. 4A, 4B, 5A-5C, 6A and 6B.

FIG. 7A shows wire clutch 700, which includes top portion 702 that can be mechanically coupled with lid 104, and bottom portion 704 that can be mechanically coupled with base 102. Top portion 702 has curved sections 710 that interleave with curved sections 712 of bottom portion 704 forming an opening in which wire 706 can be positioned. Note that the number of interleaved curved portions 710 and 712 shown in wire clutch 700 is exemplary and the number of curved portions 710 and 712 can vary. When lid 104 is rotated with respect to base 102, top portion 702 rotates with respect to bottom portion 704 along rotational axis 708. During rotation, the effective length of curved portions 710 and 712 increase through use of ramped faces, which increases tension in wire 706 and normal force on friction surfaces against movement along rotational axis 708. Tension 714 is applied to both sides of wire 706 so that wire 706 maintains a rigid substantially linear shape and does not deform upon the forces applied during rotation. Tension 714 can be provided by, for example, tightly tethering each end of wire 706 to a surface within portable computer 100. Wire 706 can be made of any suitable material, such as metal, carbon fiber, polymer, ceramic, rubber, or a combination thereof. In some embodiments, a lubricant is provided between interior surface of curved sections 710/712 and wire 706.

FIG. 7B shows wire clutch 720, which is similar to wire clutch 700 but includes a number of wires 726. Wire clutch includes top portion 722, which can be mechanically coupled with lid 104, and bottom portion 724, which can be mechanically coupled with base 102. Top portion 722 has curved sections 730 that interleave with curved sections 732 of bottom portion 724 forming an opening in which wires 726 can be positioned. The number of interleaved curved portions 730 and 732 can vary. The numbers and thicknesses of wires 726 can vary. In some embodiments, wires 726 each have substantially the same thickness. In other embodiments, wires 726 each have different thickness. Wires 726 can be made of any suitable material, such as metal, carbon fiber, polymer, ceramic, rubber, or a combination thereof. Wires 726 can each be made of the same material or be made of different materials. In some embodiments, wires 726 are in a twisted configuration. When lid 104 is rotated with respect to base 102, top portion 722 rotates with respect to bottom portion 724 along rotational axis 728. During rotation, the effective length of curved portions 730 and 732 increase through use of ramped faces, which increases tension in wire 726 and normal force on friction surfaces against movement along rotational axis 728. Tension 734 is applied to both sides of wires 726 so that wires 726 maintain a rigid overall linear shape and do not deform upon the forces applied during rotation. Tension 734 can be provided by, for example, tightly tethering each end of wires 726 to a surface within portable computer 100. In some embodiments, a lubricant is provided between interior surface of curved sections 730/732 and wires 726.

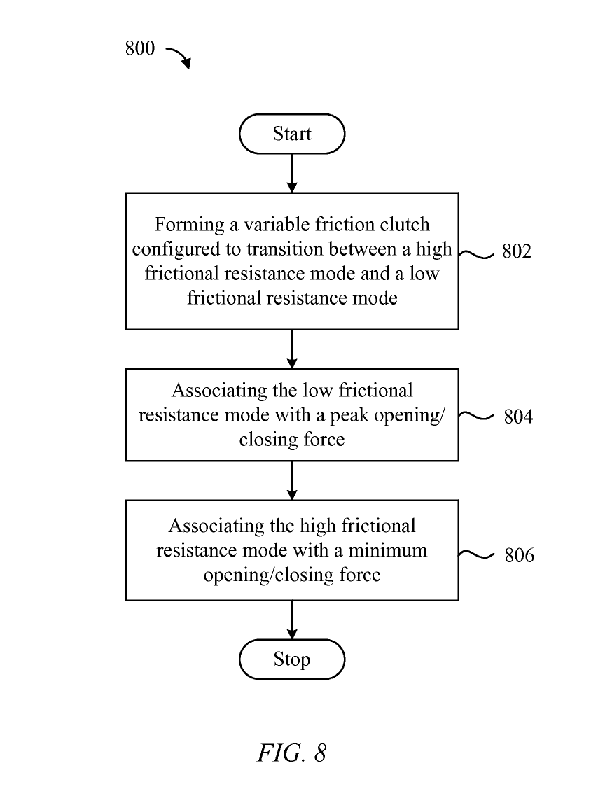

FIG. 8 shows flowchart 800, which indicates a process for customizing a hinge assembly for a portable computer in accordance with some embodiments. At 802, a variable friction clutch is formed. The variable friction clutch provides a variable frictional resistance. The variable friction clutch is configured to transition between a high frictional resistance mode and a low frictional resistance mode. The variable friction clutch provides a high frictional resistance when in the high frictional resistance mode and a low frictional resistance with in the low frictional resistance mode. The variable friction clutch can include a number of high frictional resistance modes and/or a number of low frictional resistance modes. The amount of frictional resistance change when transitioning between the high and low frictional resistance modes can vary depending upon the design of the variable friction clutch.

The type of variable fiction clutch can vary depending upon a number of factors, including a desired amount of frictional resistance at particular points of movement of the clutch. In some embodiments, the variable friction clutch includes a cam system, such as described above with reference to FIGS. 4A and 4B. In some embodiments, the variable friction clutch includes a threaded shaft system, such as described above with reference to FIGS. 5A-5C. In some embodiments, the variable friction clutch includes a mechanical linkage system, such as described above with respect to FIGS. 6A and 6B. In some embodiments, the two or more variable friction clutches are included within a single hinge assembly for the portable computer. The two or more variable friction clutches can include the same or different types of variable friction clutches. For example, one or more cam system clutches can be combined with one or more threaded shaft system clutches and/or mechanical linkage system clutches. That is, any suitable combination of the variable friction clutches describe above can be combined within a single hinge assembly for the portable computer.

In some embodiments, one or more variable friction clutches are combined with one or more non-variable friction type clutches within a single hinge assembly for a portable computer. For example, one or more of the variable friction clutches described above with reference to FIGS. 4-6 can be combined with one or more wire clutches, such as described above with reference to FIGS. 7A and 7B. In some embodiments, one or more variable friction clutches are combined with one or more counter-balances clutches. A counter-balanced clutch can include a mechanism, such as a spring, that provides a counter-balancing force to the clutch and stabilizes the opening and/or closing motions of a lid with respect to a base of a portable computer. Additionally, or alternatively, the variable friction clutch can be used in combination with a constant friction clutch system that can turn at different speeds via linkages, cams, gears or other suitable mechanisms.

At 804, the low frictional resistance mode of the variable friction clutch is associated with a peak opening force and/or peak closing force of a hinge system. This can have the effect of reducing the peak opening force and/or peak closing force of the hinge system. At 806, the high frictional resistance mode of the variable friction clutch is associated with a minimum opening force and/or a minimum closing force of the hinge system. This can have the effect of increasing the minimum opening force and/or minimum closing force of the hinge system. The resulting hinge assembly can then provide a smoother and more consistent opening and closing motion for the user. In some embodiments, the hinge assembly includes a number of variable friction clutches. In these cases, the combination of variable friction clutches can be configured to cooperate to provide a combined variable friction resistance. The variable friction clutches can be configured to transition between a combined high frictional resistance mode and a combined low frictional resistance mode. Accordingly, the combined low frictional resistance mode of the variable friction clutches can be associated with and reduce a peak opening force and/or peak closing force of a hinge system. Similarly, the combined high frictional resistance mode of the variable friction clutches can be associated with and increase a minimum opening force and/or minimum closing force of a hinge system.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A variable friction clutch rotatably coupling a first piece and a second piece, the variable friction clutch comprising:
a fork comprising two extended members that cooperate to define a notch; and
a cam shaft having a variable engagement surface that frictionally engages the two extended members in a manner that provides a resistance that varies in accordance with an angular displacement between the first and second pieces.

2. The variable friction clutch of claim 1, wherein the variable frictional resistance provides a consistent opening force and/or a consistent closing force associated with the angular displacement between the first and second pieces.

3. The variable friction clutch of claim 1, wherein the cam shaft transitions between a high frictional resistance mode and a low frictional resistance mode when the cam shaft rotates within the notch, the high frictional resistance mode providing a high frictional resistance and the low frictional resistance mode providing a low frictional resistance.

4. The variable friction clutch of claim 3, wherein the low frictional resistance mode is associated with and reduces a peak opening force associated with the angular displacement between the first and second pieces.

5. The variable friction clutch of claim 3, wherein the high frictional resistance mode is associated with and increase a minimum opening force associated with the angular displacement between the first and second pieces.

6. The variable friction clutch of claim 1, wherein the variable frictional clutch is part of a hinge assembly for a portable computer, the cam shaft having a rotational axis corresponding to a rotational axis of the hinge assembly.

7. The variable friction clutch of claim 6, wherein the hinge assembly comprises multiple variable friction clutches, wherein the variable friction clutches cooperate together to provide a combined variable friction resistance.

8. The variable friction clutch of claim 6, wherein the hinge assembly rotatably couples a base and a lid of a portable computer.

9. The variable friction clutch of claim 8, wherein the lid includes a screen and the base houses internal operational components.

10. The variable friction clutch of claim 6, wherein the hinge assembly further comprises a counter-balanced spring clutch system.

11. A portable computer having a base and a lid, the portable computer comprising:
a hinge assembly rotatably coupling the base and the lid such that the lid rotates with respect to the base along a rotational axis, the hinge assembly including a variable friction clutch comprising:
a fork having a notch defined by two extended members, and
a cam shaft positioned within the notch and frictionally coupled to the two extended members, the cam shaft having a rotational axis corresponding to the rotational axis of the hinge assembly, the cam shaft having a non-circular cross-section that provides a variable frictional force when the cam shaft rotates within the notch, wherein the variable frictional force is associated with a variable opening force curve of the hinge assembly.

12. The portable computer of claim 11, wherein the variable frictional force is associated with a variable closing force curve of the hinge assembly.

13. The portable computer of claim 11, wherein the cam shaft is mechanically coupled to the lid and the fork is mechanically coupled to the base.

14. The portable computer of claim 11, wherein the cam shaft is mechanically coupled to the base and the fork is mechanically coupled to the lid.

15. The portable computer of claim 11, wherein the lid includes a screen and the base houses internal operational components.

16. The portable computer of claim 11, wherein the hinge assembly further comprises a counter-balanced spring clutch system.

17. A method of customizing a hinge assembly for a portable computer, the method comprising:
forming a variable friction clutch configured to provide a variable frictional resistance, the variable friction clutch configured to transition between a high frictional resistance mode and a low frictional resistance mode;
associating the low frictional resistance mode of the variable friction clutch with a peak opening force and/or peak closing force of the hinge assembly; and
associating the high frictional resistance mode of the variable friction clutch with a minimum opening force and/or a minimum closing force of the hinge assembly.

18. The method of claim 17, wherein the hinge assembly includes multiple variable friction clutches, wherein the variable friction clutches cooperate together to provide a combined variable friction resistance.

19. The method of claim 18, wherein the variable friction clutches are configured to transition between a combined high frictional resistance mode and a combined low frictional resistance mode, wherein the associating the low frictional resistance mode comprises:
associating the combined low frictional resistance mode with the peak opening force and/or peak closing force of the hinge assembly.

20. The method of claim 18, wherein the variable friction clutches are configured to transition between a combined high frictional resistance mode and a combined low frictional resistance mode, wherein the associating the high frictional resistance mode comprises:
associating the combined high frictional resistance mode with a minimum opening force and/or a minimum closing force of the hinge assembly.
